(19) United States
(12) Patent Application Publication
(10) Pub. No.: US 2026/0054766 A1
(43) Pub. Date: Feb. 26, 2026

(54) WHEELCHAIR CONFIGURED TO TRAVERSE SANDY TERRAIN

(71) Applicant: Innovative and Reflective Designs LLC, Sarasota, FL (US)

(72) Inventors: Robert Samuel, Sarasota, FL (US); Indumathi Samuel, Sarasota, FL (US)

(21) Appl. No.: 19/302,892

(22) Filed: Aug. 18, 2025

Related U.S. Application Data
(60) Provisional application No. 63/686,132, filed on Aug. 22, 2024.

(51) Int. Cl. B62B 9/12; A61G 5/12; B62B 7/04

(52) U.S. Cl. CPC B62B 9/12; A61G 5/122; B62B 7/04; B62B 2202/00; B62B 2202/52

(57) ABSTRACT

A wheelchair or wagon made of light material that is resistant to corrosion from the salty atmosphere that may be found in beaches and that can be folded to fit in the back of conventional cars, minivans or SUVs without the need for disassembly. In one form, the wheelchair can be used to push a person that is seated upright on sandy terrain, with the use of inflatable balloon tires and a footrest to protect the feet. In another form the frame may be made longer and shorter for a person to be seated in a prone position with their legs stretched out and the wagon pulled with the use of a foldable handle at the front.

### FIELD

The present disclosure relates to the field of vehicles, and particularly to wheelchairs and related vehicles configured to transport humans.

### BACKGROUND

Conventional wheelchairs are relatively heavy and have wheels that are not suitable for sandy terrain, thus allowing the wheels to sink into the sand. Some wheelchairs have been made with larger balloon wheels, but these wheelchairs are too large to fit in the back of many vehicles, especially if the rear seats are not folded. Additionally, beach wheelchairs are often made of expensive custom hardware that make it impossible for many to afford.

In view of the foregoing, it would be desirable to provide a wheelchair that is configured for use at a beach and may be easily stored in the back of conventional cars or minivans. It would also be advantageous for the wheelchair to not require disassembly in order to store the wheelchair, and for the wheelchair to thus be simpler and easier to use. Moreover, it would be advantageous for the wheelchair to be easily manufactured and relatively inexpensive to produce, thus providing a more affordable beach wheelchair.

### SUMMARY

The present disclosure is related to a wheelchair formed from relatively inexpensive material, such as light-weight PVC piping and off-the-shelf pipe fittings as well as polymer strips that are interwoven to form the support for the person. The materials and construction methods used to assemble the wheelchair make the wheelchair more affordable and easier to use. The wheelchair is also foldable, thus allowing the wheelchair to be easy to transport in a standard sized car or minivan, and allowing for transportation of the person needing the wheelchair and their companions along with luggage in standard vehicles that are not customized.

People with disabilities, especially children, do not typically need full-sized wheelchairs. The design disclosed herein uses standard low-cost hardware. The wheelchair may be smaller and custom scaled to suit people that do not have normal human body proportions (e.g., those individuals who do not have the proportions of a typical full-sized adult).

The wheelchair disclosed herein is comprised of a durable and water-resistant webbing that is attached to a frame. For example, the webbing may be comprised of strips of a polymer material such as polyvinylchloride, polyethylene or nylon. The strips may be an extruded material or a fabric (e.g. woven from polymer fibers). The strips are cut to appropriate lengths and wrapped around the frame members, and interwoven with each other before fastening the ends to the frame. This material can be sourced with different attractive colors to make it pleasing to the people using the wheelchairs, especially children.

In at least some embodiments, the wheelchair is provided in the form of a wagon. Some people using this wagon, particularly children, may not want to be fully restrained and may want to touch the surface of the balloon wheels while in motion, which may not be safe or hygienic for them. Accordingly, the frame can be designed to contain wings that extend over the top of the balloon tires closest to the arms of the person. The size of the wings can be designed in such a way that the extension of the envelope of the wagon is minimized.

In at least one embodiment disclosed herein, a wheelchair wagon includes a frame comprised of a plurality of tubes interconnected with tubular couplings with webbing coupled to the frame. The webbing includes a plurality of interwoven strips of material that extend between the plurality of tubes. The frame and webbing together form a bed configured to receive a human, wherein the bed is defined by a plurality of panels including a front panel, two side panels, and a rear panel. An undercarriage is also provided along a bottom panel of the bed. The undercarriage includes at least two wheels rotatably coupled to the frame and arranged laterally outward from the two side panels. Two wings extend laterally outward from a top of the side panels, wherein the wings cover at least most of the two wheels. A drawbar is pivotably coupled to the front panel.

In yet another embodiment disclosed herein, a kit for a wheelchair wagon includes a package with a plurality of components positioned in the package. The components include a plurality of separate tubes configured to be assembled into a frame and a drawbar for the wheelchair wagon. The components further include a plurality of tubular couplings configured to receive ends of the tubes and allow the frame to be assembled from the plurality of separate tubes. The components also include webbing configured to extend between the tubes on the assembled frame. At least two wheels are positioned in the package and configured to be connected to the assembled frame by at least one axle extending through one of the tubes of the frame.

The above described features and advantages, as well as others, will become more readily apparent to those of ordinary skill in the art by reference to the following detailed description and accompanying drawings. While it would be desirable to provide a wheelchair and related method for transporting people that provides one or more of these or other advantageous features as may be apparent to those reviewing this disclosure, the teachings disclosed herein extend to those embodiments which fall within the scope of the appended claims, regardless of whether they include or accomplish one or more of the advantages or features mentioned herein.

### BRIEF DESCRIPTION OF THE DRAWINGS

FIG. 1 shows a perspective view of a foldable wheelchair in the form of a wheelchair wagon;

FIG. 2 shows a perspective view of the wheelchair wagon of FIG. 1 with a seatback and a handle of the wagon in a folded positon;

FIG. 3 shows a side view of the wheelchair wagon of FIG. 1;

FIG. 4 shows a front view of the wheelchair wagon of FIG. 1;

FIG. 5 shows a rear view of the wheelchair wagon of FIG. 1;

FIG. 6 shows a top view of the wheelchair wagon of FIG. 1;

FIG. 7 shows an enlarged view of a protective wing on a side of the wheelchair wagon of FIG. 1;

FIG. 8 shows an enlarged view of strips of nylon fabric wrapped around frame members and interwoven to form parts of the body of the wheelchair wagon of FIG. 1;

FIG. 9 shows a perspective view of an alternative embodiment of the wheelchair wagon of FIG. 1, wherein the wheelchair wagon is more upright and provided in the form of a chair-like structure;

FIG. 10 shows a perspective view of the wheelchair wagon of FIG. 9 with the seatback in a folded position; and

FIG. 11 shows a kit for assembling the wheelchair wagon of FIG. 1, including various components of the wheelchair wagon provided within a package.

### DESCRIPTION

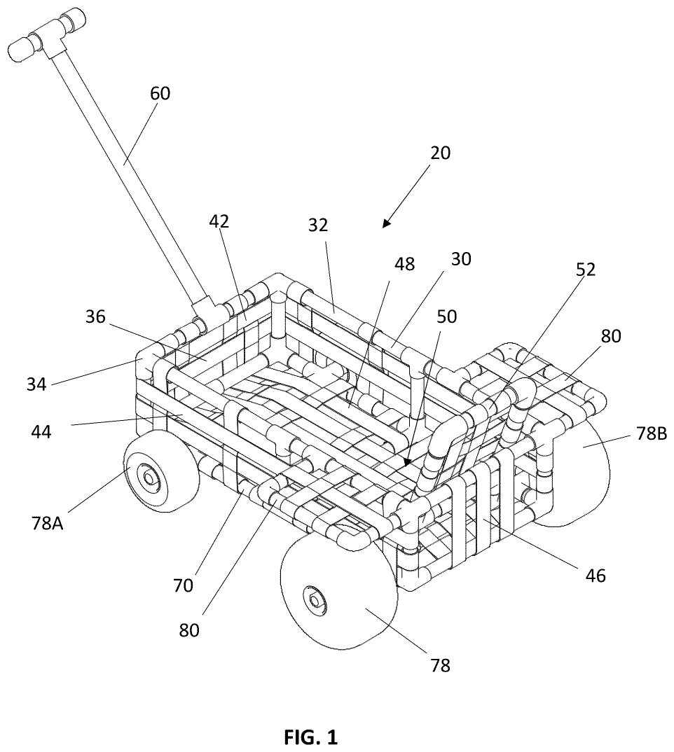

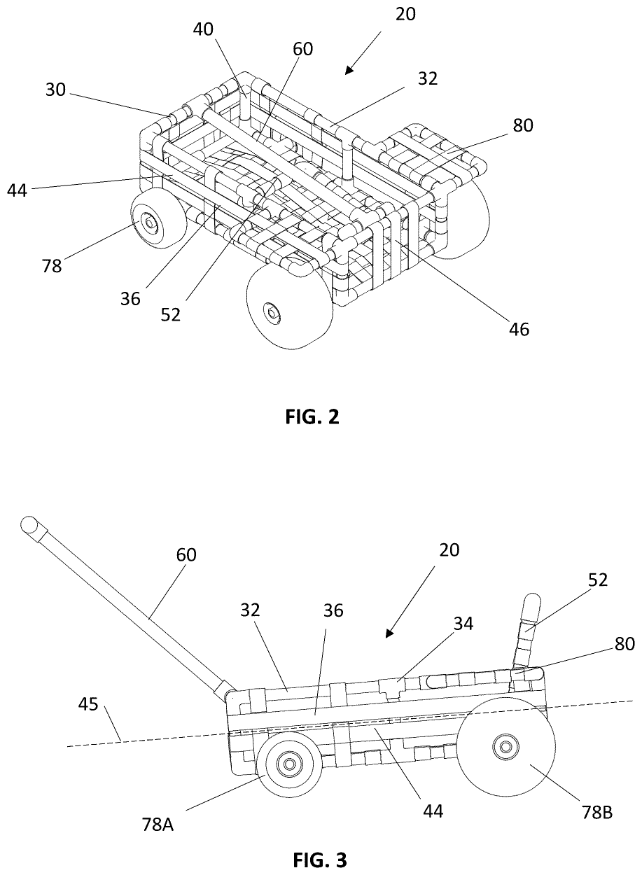

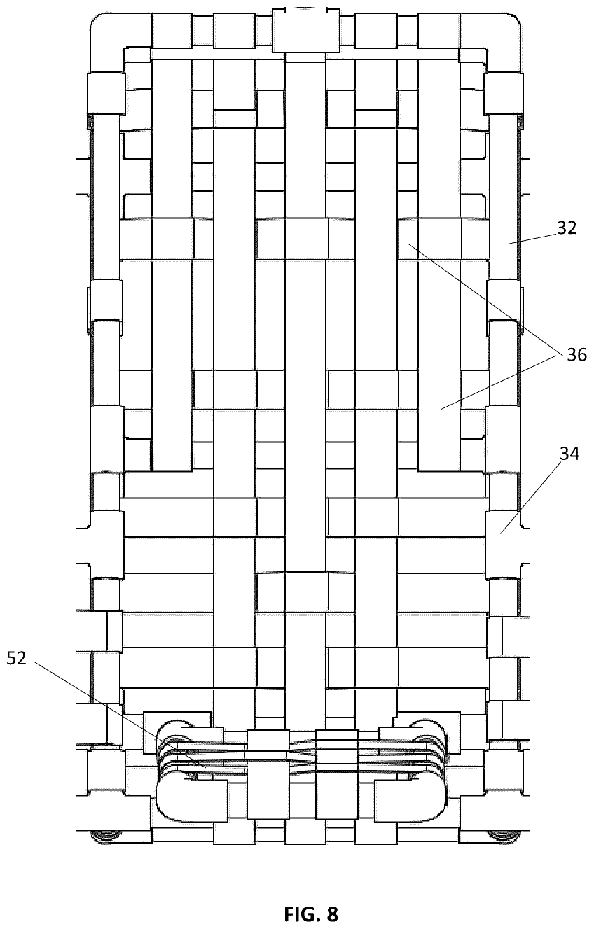

With reference to FIGS. 1-8, a foldable wheelchair wagon 20 is disclosed. The wheelchair wagon 20 is configured to transport people or materials over sandy terrain, mud, or other loose ground conditions. The wheelchair wagon comprises a frame 30 made up of tubes 32 and tubular couplings 34. Webbing 36 is fastened between opposing members of the frame to provide a cushioned support for humans positioned in the wagon 20.

The tubes 32 that form the frame 30 are typically lightweight hollow members, such as polyvinyl chloride (PVC) pipes. Each tube 32 used to form the frame 30 is defined by a length of cylinder with two opposite ends. The tubes 32 may all be the same diameter (e.g., 1″ to 2″ diameter tubes) or may be different diameter tubes 32 in different portions of the frame 30 (e.g., 1″ tubes on some parts of the frame and 1.25″ tubes on other parts of the frame). Additionally, one or more different colors of tubes 32 may be used to form the frame 30. For example, in some embodiments, the tubes 32 are all white while in other embodiments, a combination of white, black, blue, yellow, clear or other color tubes may be used. As explained in further detail below, the colors may be selected by the party that assembles the frame 30.

The tubular couplings 34 are configured to interconnect the tubes 32 by joining ends of the tubes 32 to other tubes and thereby form the frame 30. In at least some embodiments, the tubular couplings 34 are PVC fittings. Each PVC fitting is configured to join two or more lengths of tube. Any number of different types of PVC fittings may be used, such as tee fittings, slip T fittings, 3-way elbow fittings, and 4-way fittings. With tee fittings, stops may be provided in each of the three collars/ports of the fitting, wherein each port is configured to receive the end of a PVC pipe. With slip T fittings, a first pipe is inserted through a cylindrical passage that is free of stops and the end of a second pipe is inserted into a third port. With 3-way elbow fittings, three different tubes in different planes may be coupled together, such as joining the edges at a corner of a box. With 4-way fittings, three tubes in one plane may be connected to another tube in a perpendicular plane, or two tubes in one plane may be connected to two tubes in a perpendicular plane. Of course, these are only a few different examples of tubular couplings 34 that may be used to join the tubes 32 that form the frame, and it will be recognized that any number of different types of couplings may be used to connect the tubes that form the frames.

The tubes 32 may be fixedly or moveably joined to the couplings 34 in any of a number of different manners. For example, in at least some embodiments adhesive glue, such as PVC pipe cement, is used to join the tubes 32 to the couplings 34. In other embodiments, screws or other fasteners may be used to join the tubes 32 to the couplings. When adhesives or fasteners are used to join the tubes 32 to the couplings 34 a fixed connection is provided. In additional embodiments, one or more of the tubes 32 may be joined to the couplings 34 using only a friction fit. A friction fit allows the tubes 32 to be moveable relative to one another and/or easily removed at the discretion of the user in order to tear down or separate different parts of the frame 30 without destruction of the components and subsequently re-build the frame 30 when desired.

Webbing 36 extends between different tubes 32 on the frame 30. The webbing 36 is comprised of elongated strips of relatively strong, durable material. In at least one embodiment, the webbing is comprised of a polymer material such as polyvinylchloride, polyethylene or nylon. In various embodiments, the strips may be an extruded material (e.g., a tape) or a fabric (e.g. woven from polymer fibers). Similar to the tubes 32 and couplings 34, the material used for the webbing 36 may be sourced with different attractive colors to make it pleasing to the people using the wagon wheelchairs, especially children.

The webbing 36 and the frame 30 are used to form a bed 40 of the wheelchair wagon 20. When assembling the bed 40, the strips of webbing 36 are cut to appropriate lengths, and the ends of the individual strips are wrapped around different tubes 32. Accordingly, the webbing 36 extends between and connects different tubes 32 on the frame 30. The opposing ends of the individual strips of webbing 36 are tightly fastened to the different tubes using an adhesive or other fastening means. In at least one embodiment, the ends of the webbing 36 wrap completely around each tube one or more times in order to secure the webbing 36 on the frame 30. In these embodiments adhesive may be pre-applied to the ends of the strips of webbing and a backing layer may be removed prior to wrapping the end of the webbing around one of the tubes. In other embodiments, the adhesive may be applied to the end of the webbing as it is wrapped around the tube. In other embodiments, webbing that is wrapped around the tube may adhere to itself (e.g., with a surface-friction lock) in order to secure the webbing to the tube.

The strips of material that form the webbing 36 are interwoven and/or cross one another and form a lattice/net-like structure on the frame 30. When fully assembled, the frame 30 and webbing 36 together form the bed 40 of the wagon. The bed 40 is defined by a plurality of panels including a front panel 42, two side panels 44, and a rear panel 46. The bed 40 also includes a floor panel 48. The floor panel 48 may also provide a portion of an undercarriage 70 for the wagon, as explained in further detail below. The bed 40 defines a volume having a sufficient length and depth such that it is configured to receive and retain a human. In some embodiments, the bed 40 is configured to receive and retain a human child; in other embodiments, the bed 40 is configured to receive and retain a human adult.

A seat 50 is provided in the bed 40 of the wheelchair wagon 20. The seat 50 is configured to receive a human and provide a backrest support for the human sitting in the seat 50. In at least some embodiments, the backrest 52 of the seat is a foldable backrest that is movable between an upright position and a downward position. The backrest 52 is sufficiently tall such that an upper portion of the backrest extends above an upper perimeter of the two side panels 44 and the rear panel 46 of the bed 40 when the backrest is in the upright position. At the same time, the backrest 52 is sufficiently short to fold within the confines of the bed 40 of the frame when in the downward position. In at least some embodiments, the backrest 52 is coupled to a cross-tube on the floor panel 48 of the bed 40. This coupling may be made with two slip T fittings provided at opposite sides at the base of the backrest 52 and connected to the floor panel 48 of the bed 40. The slip T fittings allow the backrest 52 to pivot within the bed 40 with respect to the floor panel 48 of the bed. The rear panel 46 of the bed 40 limits the extent to which the backrest 52 may pivot backward. The floor panel 48 of the bed 40 limits the extent to which the backrest 52 may pivot forward.

The wheelchair wagon 20 further includes a foldable drawbar 60 that may be used to pull the wagon. The drawbar 60 includes a pivoting coupling at one end that is connected to the front panel 42 of the bed 40. The pivoting coupling for the drawbar 60 may be provided by a slip-T fitting that is coupled to a cross-tube on the front panel 42 of the bed 40, such as a cross-tube that defines an upper perimeter of the front panel 42. The foldable/pivoting drawbar 60 can be extended to a forward position or folded back to a recessed position. In the forward position, the drawbar 60 projects outward from the front panel and is configured to allow a user to pull the wheelchair wagon 20. The drawbar further includes a handle (which drawbar and handle may be collectively referred to as simply a “handle”) that is used to pull the wagon when the drawbar is in the forward position. In the recessed position, the drawbar 60 is conveniently retained within the confines of the bed 40 of the frame 30.

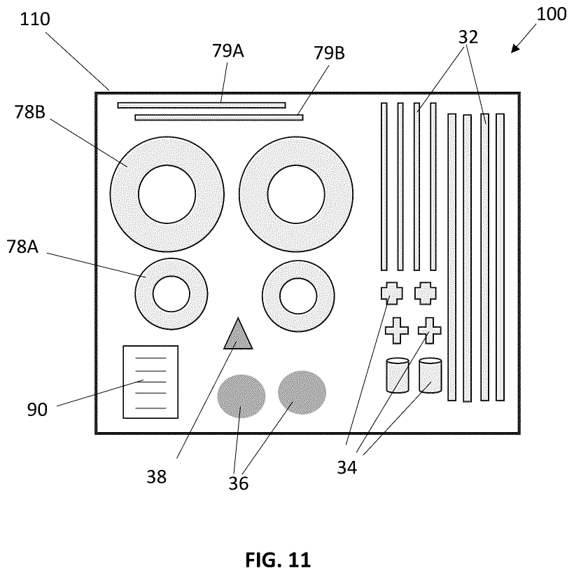

The wheelchair wagon 20 further includes an undercarriage 70 positioned under the frame 30. The undercarriage includes two of the cross-tubes 74 that extend across the floor panel 48 of the bed 40, two rotatable axles (79A, 79B, not shown in FIGS. 1-8; see FIG. 11) that extend through the cross-tubes 74, and a plurality of wheels 78. The wheels 78 include two front wheels 78A and two rear wheels 78B. A front axle connects the two front wheels 78A and a rear axle connects the two rear wheels 78B. The wheels 78 may be low-pressure inflatable balloon wheels, wherein each wheel 78 includes an interior hub surrounded by a tire. The tires of the balloon wheels 78 are comprised of a soft material such as polyurethane and are configured to more smoothly traverse soft ground such as sand. Low-pressure inflatable balloon wheels also have a maximum recommended inflation of less than ten pounds per square inch (psi), such as two to three psi. Balloon wheels also have a width (i.e., as measured from an interior sidewall to an exterior sidewall) that is at least 40% of the height (as measured by the diameter from a top to bottom of the wheel). One example of low pressure balloon wheels are those sold by Wheeleez, Inc. of Fairfield, California. In some embodiments, the wheels 78 are may may be the same or dissimilar between the front and the back (e.g., see FIG. 3).

The wheels 78 are attached to the frame by means of the axles that extend through the hollow tubing of the frame, and particularly the cross-tubes 74 in the floor panel 48 of the bed 40. The axles may be made of materials that do not corrode easily in a salty atmosphere, such as marine grade anodized aluminum. The axles are connected to the hubs of the wheels. In at least some embodiments, the axles are hollow. The axles may be connected to the hubs by any appropriate means such as welding or mechanical devices such as hitch pins. One axle connects the two front wheels 78A and another axle connects the two rear wheels 78B, Because the two front wheels 78A are connected by a common axle, they do not swivel and are locked in a forward directed position relative to the frame 30. The same is the case for the two rear wheels 78B. In other words, each of the front wheels 78A and the rear wheels 78B is locked in place along a radial plane defined by the wheel that is parallel to an associated side panel 44 of the bed 40 (which radial plane of the wheel is also perpendicular to the floor panel 48). While the front wheels 78A and rear wheels 78B are able to rotate about their axis in the radial plane, the position of each wheel within the radial plane does not change, and the wheel is not able to turn into other planes that are not parallel to the associated side panel 44.

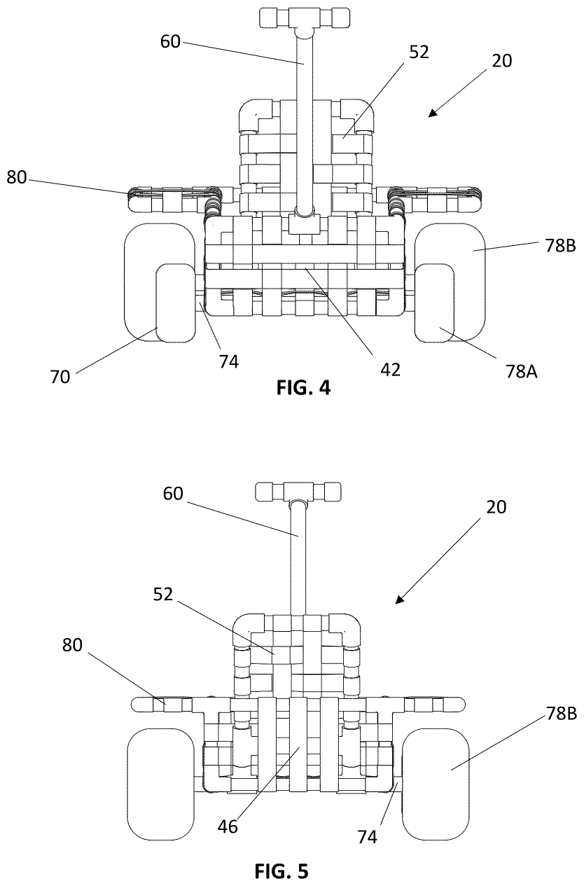

As illustrated in the figures herein, in at least some embodiments of the wheelchair wagon 20 there are differences in the size of the front wheels 78A and the size of the rear wheels 78B, and these sizes contribute to the compact design of the wagon. For example, in the embodiments disclosed herein the front wheels are smaller than the rear wheels (e.g., the diameter of the front wheels is 75% or less the diameter of the rear wheels). When the rear wheels 78B are larger than the front wheels 78A, the bed 40 of the wagon has a forward facing slope for the person seated in the wagon, as illustrated in FIGS. 3 and 4 (i.e., the floor panel 48 is at a higher vertical position at the rear panel 46 than at the front panel 42). However, in other embodiments it will be recognized that the front wheels 78A and the rear wheels 78B are identical in size. In these embodiments, the bed 40 of the wagon, including the floor panel 48) is generally level.

As illustrated in the figures herein, the larger wheels in the back are advantageously placed to support the majority of the weight of the person which is towards the back of the wagon 20. The smaller wheels in the front will bear a much smaller load due to the same reason. This lighter load allows for the easy maneuvering of the wagon 20 without the need for a swiveling arrangement of any of the wheels, front or back. This design also allows for further reduction of the weight of the wagon.

Because the undercarriage 70 is so close to the floor 48 of the bed with the axles extending through cross-tubes 74 in the floor panel 48, the wheelchair wagon rides relatively close to the ground. In particular, the floor panel 48 rides is slightly less than the radius of the wheels 78 above the ground. Also, because the rear wheels 78B have a greater radius than the front wheels 78A, the wagon may be forwardly pitched, as best illustrated in FIG. 3. For example, the wagon may be forwardly pitched by 5°-15°. Additionally, because the undercarriage is so close to the ground, the wheels 78 that are arranged laterally outward from the side panels 44 extend a significant height upward along the side panels 44. For example, as shown in FIG. 3, the front wheels 78A extend to a centerline 45 of the side panels (i.e. a central vertical height on the side panels 44 between the floor panel 48 and the upper perimeter edge of the side panels). As also shown in FIG. 3, the rear wheels 78B extend above the centerline 45. This arrangement is advantageous because it provides a low center of gravity for the wheelchair wagon 20, making it extremely unlikely that the wagon will tip during use.

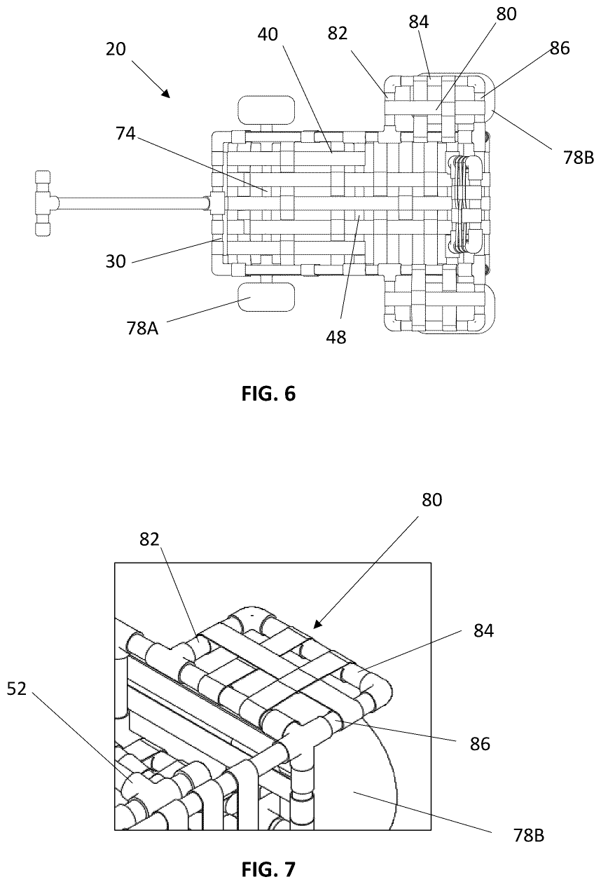

The wheelchair wagon 20 further includes two wings 80 positioned over the two rear wheels 78B. Each wing 80 is comprised of a plurality of tubes 32 with webbing 36 extending between the tubes. The webbing on the wings 80 is sufficiently tight and dense to prevent a rider from inserting his or her hand through the wing 80. Accordingly, the wings 80 may serve as armrests for the rider. In the embodiment disclosed herein, the wings 80 are generally rectangular in shape and extend outward from a top perimeter of the side panels 44, substantially perpendicular to the side panels 44 and parallel to the floor panel 48. As best shown in FIG. 6, the wings 80 cover most of the wheels 78B such that only a small portion of a rearward side and laterally outward side of each wheel 78B is visible outside of the wing 80 when the wheelchair wagon 20 is viewed from a position directly above the wing 80 (i.e., a vertical projection of the wing covers at least 50% of the associated wheel, and in some embodiments 90% or more of the associated wheel). Accordingly, a front perimeter edge 82 of each wing 80 is positioned forward from the forward edge of the associated wheel 78B. A lateral perimeter edge 84 of each wing 80 is positioned slightly inside of (i.e., within four inches inward from) the laterally outward side of each wheel 78B. Also, a rear perimeter edge 86 of each wing 80 is positioned slightly forward from and over (i.e., within six inches forward from) the rear edge of the associated wheel 78B.

The wings 80 are advantageously arranged over the top of the inflatable low pressure tires in order to act as a barrier for the person in the wagon. The wings specifically cover the larger rear wheels 78B of the wagon and prevent a person riding in the wagon from accidentally (or purposefully) engaging the wheels, thus providing a safety barrier for the rider. As noted above, it will also be recognized that the wings 80 may serve as armrests for the rider.

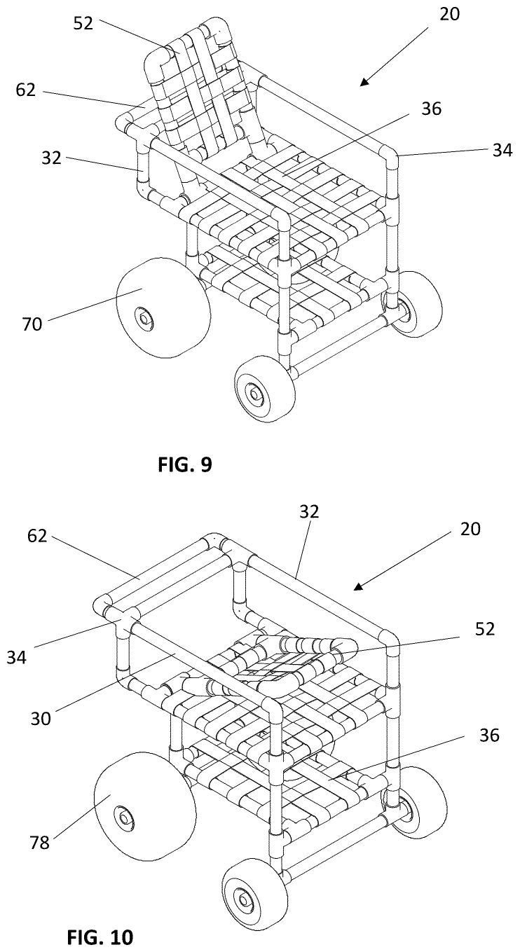

While the wheelchair wagon has been described herein as being a low-riding wagon wherein the rider is relatively close to the wheels, the wheelchair may be configured differently in other embodiments. For example, in at least some embodiments, the wheelchair is not wagon-like and instead has a taller base and is more chair-like, thus allowing a person to sit upright as shown in FIGS. 9 and 10. In this embodiment, the wheelchair does not include the drawbar 60 and instead includes a push bar 62 which is provided by a tube connected to the back of the frame 30 behind the foldable backrest 52. The wheelchair shown in FIGS. 9 and 10 may also include a foldable footrest (not shown in the figures) positioned to prevent the feet of the person riding in the device from touching the ground. In order to make the size of the wheelchair more compact, the wheelchair may not include the wings 80.

With reference now to FIG. 11, in at least one embodiment, the wheelchair wagon 20 is sold as a kit 100 for assembly by a purchaser of the kit. The kit includes a package 110 that contains all the components required to assemble the wheelchair wagon 20. The package 110 may be, for example, a cardboard box or plastic container that holds all of the components of the wheelchair wagon.

The components retained within the package 110 include a plurality of separate tubes 32. The tubes 32 are designed and dimensioned to be assembled into the frame 30 of the wheelchair wagon 20. One or more tubes 32 are also provided in the package 110 for the drawbar of the wheelchair wagon 20. The package 110 further includes a plurality of tubular couplings 34 that are configured to receive ends of the tubes 32 and allow the frame 30 to be assembled from the plurality of separate tubes 32. Glue 38 or other adhesive material may be included in the package 110 for use in permanently securing at least some of the tubing together when forming the frame 30. Webbing 36 is also positioned in the package 110. The webbing 36 is configured to be coupled to the tubes 32 and extend between the tubes 32 on the assembled frame 30 in order to form the bed 40 and the wings 80 of the wagon.

At least two wheels, and more specifically two front wheels 78A and two rear wheels 78B are also positioned in the package, along with two axles 79A and 79B. The two front wheels 78A are configured to be connected to the assembled frame by a first axle 79A extending through one of the tubes 32 of the frame. The two rear wheels 78B are configured to be connected to the assembled frame by a second axle 79B extending through one of the tubes 32 of the frame. When assembled, the front axle 79A extends between the two front wheels 78A and through one of the plurality of tubes of the assembled frame, and the rear axle 79B extends between the two rear wheels 78B and through another of the plurality of tubes of the frame.

The kit further includes a printed instruction sheet 90 or a link or QR code to an online instruction sheet including instructions for assembly of the wheelchair wagon 20 using the components positioned within the package. When assembled, the frame 30 of the wheelchair wagon includes a bed 40 defined by a plurality of panels including a front panel 42, two side panels 44, a rear panel 46, a floor panel 48, and two wings 80 extending laterally outward from a top of the side panels. The assembled frame 30 may further include a backrest 52 positioned within the bed 40, the backrest 52 pivotable between an upright position wherein a top portion of the backrest is arranged above the bed and a downward position wherein the top portion of the backrest is arranged within the bed. The drawbar 60 of the wheelchair wagon is pivotable on the assembled frame 30 between a forward position wherein the drawbar extends outward from the bed and a recessed position wherein the drawbar is arranged completely within the bed.

Following assembly, the two front wheels 78A are uncovered on a front side of the bed of the assembled frame, and at least most of the two rear wheels 78B are covered by the two wings of the assembled frame, as shown in FIG. 3. Front edges of the two wings 80 are positioned forward of the two rear wheels and rear edges of the two wings are positioned over a rear portion of the two rear wheels.

In at least some embodiments, the components within the package 110 are custom-ordered by the purchaser in order to allow the purchaser to build a custom wheelchair wagon with a custom size and custom colors. For example, the size of the frame 30 and the wheels may be ordered to custom sizes and the seller of the wheelchair may insert the appropriate sized tubing and webbing into the package based on the custom size. Similarly, the tubes 32 and webbing may be ordered to custom colors, including differently colored tubes and webbing sections, thus allowing the purchaser to build a custom wheelchair wagon that meets his or her individuals design preferences.

Although the various embodiments of a wheelchair wagon have been provided herein, it will be appreciated by those of skill in the art that other implementations and adaptations are possible. Furthermore, aspects of the various embodiments described herein may be combined or substituted with aspects from other features to arrive at different embodiments from those described herein. Thus, it will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A wheelchair wagon comprising:
a frame comprised of a plurality of tubes interconnected with tubular couplings;
webbing coupled to the frame, the webbing including a plurality of interwoven strips of material that extend between the plurality of tubes, the frame and webbing together forming a bed configured to receive a human, the bed defined by a plurality of panels including a front panel, two side panels, and a rear panel;
an undercarriage provided along a bottom of the bed, the undercarriage including at least two wheels rotatably coupled to the frame and arranged laterally outward from the two side panels;
two wings extending laterally outward from a top of the side panels, the wings covering at least most of the two wheels; and
a drawbar pivotably coupled to the front panel.

2. The wheelchair wagon of claim 1 further comprising a backrest positioned within the bed, the backrest pivotable between an upright position wherein a top portion of the backrest is arranged above the bed and a downward position wherein the top portion of the backrest is arranged within the bed.

3. The wheelchair wagon of claim 2 wherein the drawbar is pivotable between a forward position wherein the drawbar extends outward from the bed and a recessed position wherein the drawbar is arranged completely within the bed.

4. The wheelchair wagon of claim 1 wherein the at least two wheels include two front wheels and two rear wheels, wherein the two front wheels are uncovered on a front side of the bed, and wherein at least most of the two rear wheels are covered by the two wings.

5. The wheelchair wagon of claim 4 wherein a front edge of the two wings are positioned forward of the two rear wheels and wherein a rear edge of the two wings are positioned over a rear portion of the two rear wheels.

6. The wheelchair wagon of claim 4 wherein the two front wheels and two rear wheels are rotatable and locked in position relative to the frame, and wherein the two rear wheels are larger than the two rear wheels.

7. The wheelchair wagon of claim 6 wherein a front axle extends between the two front wheels and through one of the plurality of tubes of the frame, and wherein a rear axle extends between the two rear wheels and through another of the plurality of tubes of the frame.

8. The wheelchair wagon of claim 4 wherein the two rear wheels extend above centerlines of the two side panels.

9. The wheelchair wagon of claim 1 wherein the at least two wheels are low pressure balloon wheels.

10. The wheelchair wagon of claim 1 wherein the webbing is comprised of a polymer material.

11. A kit for a wheelchair wagon comprising:
a package;
a plurality of separate tubes positioned in the package, the plurality of separate tubes configured to be assembled into a frame and a drawbar for the wheelchair wagon;
a plurality of tubular couplings positioned in the package, the plurality of tubular couplings configured to receive ends of the tubes and allow the frame to be assembled from the plurality of separate tubes;
webbing positioned in the package, the webbing configured to extend between the tubes on the assembled frame; and
at least two wheels positioned in the package, the at least two wheels configured to be connected to the assembled frame by at least one axle extending through one of the tubes of the frame.

12. The kit of claim 11 further comprising a printed instruction sheet or a link to an online instruction sheet including instructions for assembly of the wheelchair wagon.

13. The kit of claim 11 wherein the assembled frame includes a bed defined by a plurality of panels including a front panel, two side panels, a rear panel, and two wings extending laterally outward from a top of the side panels, the wings covering at least most of the two wheels.

14. The kit of claim 13 wherein the assembled frame further includes a backrest positioned within the bed, the backrest pivotable between an upright position wherein a top portion of the backrest is arranged above the bed and a downward position wherein the top portion of the backrest is arranged within the bed.

15. The kit of claim 13 wherein the drawbar is pivotable on the assembled frame between a forward position wherein the drawbar extends outward from the bed and a recessed position wherein the drawbar is arranged completely within the bed.

16. The kit of claim 13 wherein the at least two wheels include two front wheels and two rear wheels, wherein the two front wheels are uncovered on a front side of the bed of the assembled frame, and wherein at least most of the two rear wheels are covered by the two wings of the assembled frame.

17. The kit of claim 16 wherein a front edge of the two wings are positioned forward of the two rear wheels and wherein a rear edge of the two wings are positioned over a rear portion of the two rear wheels when the wheelchair wagon is assembled.

18. The kit of claim 16 wherein a front axle extends between the two front wheels and through one of the plurality of tubes of the assembled frame, and wherein a rear axle extends between the two rear wheels and through another of the plurality of tubes of the frame when the wheelchair wagon is assembled.

19. The kit of claim 16 wherein the at least two wheels are low pressure balloon wheels that extend above centerlines of the two side panels when the wheelchair wagon is assembled, and wherein the two rear wheels are larger than the two front wheels.

20. The kit of claim 16 wherein the plurality of separate tubes include a first plurality of tubes having a first color and a second plurality of tubes having a second color, and wherein the webbing includes at least one length of webbing having a third color that is different than the first color or the second color.
